(19) United States
(12) Patent Application Publication
(10) Pub. No.: US 2017/0084108 A1
(43) Pub. Date: Mar. 23, 2017

(54) SYSTEM AND METHOD FOR SPORTING EVENT WAGERING

(71) Applicant: Julie Smith, Lambertville, NJ (US)

(72) Inventor: Julie Smith, Lambertville, NJ (US)

(21) Appl. No.: 14/862,495

(22) Filed: Sep. 23, 2015

(51) Int. Cl. G07F 17/32

(52) U.S. Cl. CPC G07F 17/3211; G07F 17/3288; G07F 17/3237

(57) ABSTRACT

A computational device is operated to provide a user interface on client devices which presents selectable brackets comprising of list of games to be played within a specific period in real sporting events. The games included in selected bracket are presented on the user interface against each of which the user can select a probable outcome of the respective real games and the games are required to be placed in an order of maximum winning probability as predicted by the user. If the actual result of the game placed at the top rank in the bracket matches the prediction made by a user, the user is awarded highest number of points. The point allocation against correct prediction of results of games decreases from top ranked game to bottom ranked game and winner for a bracket is selected on the basis of maximum number of points earned by a user.

### FIELD OF THE INVENTION

The present invention generally relates to sports wagering systems and methods. More particularly, the present invention relates to a system and method of online sporting event wagering based on a prediction ranking system.

### BACKGROUND OF THE INVENTION

An activity widely popular among sports fans and spectators is betting on sporting events. In addition to the monetary benefits achieved from triumphant betting, betting increases a spectator's interest in and enjoyment received from watching and keeping track of the events as they progress and this increases interest in and viewership of the sports activity in general. A large and growing industry in many parts of the world is wagering on sporting events. For various types of sporting events various types of betting systems or products are available.

The popularity of online social communities is growing at a remarkable rate and the fast growing popularity reflects an enormous population of active users. Online interactive gaming has become increasingly well liked among sports and game enthusiasts. With the rapid increase of interest and use of the Internet, wagering game manufacturers have identified that a global public network, such as the Internet, can reach to various locations of the world that have official permission to present wagering games. Some jurisdictions allow legal wagering on real-life competitions such as professional or college sporting events. Any individual possessing a personal computing device such as a cell phone, a laptop, a personal computer or a personal digital assistant can connect to the Internet for processing wagering games and that being so, some wagering game manufacturers have developed wagering games that can be processed by personal computing devices and presented via online websites. Computerized wagering has largely replaced traditional wagering and computerized wagering provides many benefits to the owner and to the gambler. Computerized wagering also provides a lesser overall cost of production and management.

Prior art computerized wagering games are mostly complicated and require a great deal of efforts to calculate spreads, odds, accumulators etc. Accordingly, there is a need for an online wagering game or contest whereby, persons/sports fans/users can vicariously enjoy the excitement of wagering with no complicacy and which does not require a lot of efforts. There is also a need for an online wagering game or contest method and system whereby groups of persons/sports fans/users can pit their wagering skills against one another in a safe and legal format. Additionally, there is a need for an online wagering game or contest method and system that is fair, quick and simple, that provides sufficient feedback to the users to make the game fun to play, and that meets a variety of gaming regulations to ensure that both the owner and gambler/user are honest and fairly treated in implementing the game.

### OBJECTS OF THE INVENTION

It is an object of the present invention to solve the problems described above associated with wagering on sporting events.

Another object of the present invention is to provide a system and method of sporting event wagering which provide an online game that will provide sports fans/users the ability to compete against other sports fans/users to test their sporting knowledge and experience by predicting the winners of games and to rank those winners from ‘Most Likely’ to ‘Least Likely’ to win each game.

A further object of the present invention is to provide a system and method of sporting event wagering which hosts both free and paid online games wherein sports fans/users can earn money while playing paid online games.

A still further object of the present invention is to provide a system and method of sporting event wagering which allows the sports fans/users to wager multiple times on a same sporting event.

Still another object of the present invention is to provide a system and method of sporting event wagering where both the free and paid online games work exactly in the same way.

Details of the foregoing objects and of the invention, as well as additional objects, features and advantages of the invention will become apparent to those skilled in the art upon consideration of the following detailed description of the preferred embodiments exemplifying the best mode of carrying out the invention as presently perceived.

### SUMMARY OF THE INVENTION

The following presents a simplified summary in order to provide a basic understanding of some aspects of the disclosed invention. This summary is not an extensive overview, and it is not intended to identify key/critical elements or to delineate the scope thereof. Its sole purpose is to present some concepts in a simplified form as a prelude to the more detailed description that is presented later.

Embodiments of the present invention are directed to a system and method for sporting event wagering. A computational device having one or more processors is operated to provide a user interface in one or more client devices communicatively connected to the computational device over a network. The user interface presents a plurality of selectable brackets comprising of a list of games to be played within a specific time period in a real sporting tournament/event from various categories of sports. Once a user selects a bracket, the games included in the bracket are presented on the user interface against each of which the user can select a probable outcome of the respective real games. The user interface also enables the games included in the bracket to be placed in an order of winning probability as per the prediction of the user from most likely prediction to least likely prediction. If the actual result of the game placed at the top rank in the game slots included in the bracket matches the prediction made by a user, the user is awarded highest number of points. The point allocation against correct prediction of results of the games decrease from top ranked game to the bottom ranked game. The sporting event wagering system then selects the one or more winner users for a bracket who earn maximum number of points. A user can participate in the prediction game of sporting event wagering system on paid basis for prize money or on unpaid basis for free games.

To the accomplishment of the foregoing and related ends, certain illustrative aspects of the disclosed invention are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

In order to describe the manner in which features and other aspects of the present disclosure can be obtained, a more particular description of certain subject matter will be rendered by reference to specific embodiments which are illustrated in the appended drawings. Understanding that these drawings depict only typical embodiments and are not therefore to be considered to be limiting in scope, nor drawn to scale for all embodiments, various embodiments will be described and explained with additional specificity and detail through the use of the accompanying drawings in which:

FIG. 1 shows a general architecture of a system that operates in accordance with one embodiment of the present invention;

FIG. 2 is an exemplary screen of graphical user interface of sporting event wagering system showing bracket options in accordance with one embodiment of the present invention;

FIG. 3 is an exemplary screen of graphical user interface of sporting event wagering system showing selectable game winners and ranks within a bracket in accordance with one embodiment of the present invention;

FIG. 4 is an exemplary screen of graphical user interface of sporting event wagering system showing selected game winners and ranks within a bracket in accordance with one embodiment of the present invention;

FIG. 5 is an exemplary screen of graphical user interface of sporting event wagering system showing result and points earned in accordance with one embodiment of the present invention; and

FIG. 6 is a flow diagram illustrating steps of the method for sporting event wagering system in accordance with an embodiment of the present invention.

### DETAILED DESCRIPTION OF THE INVENTION

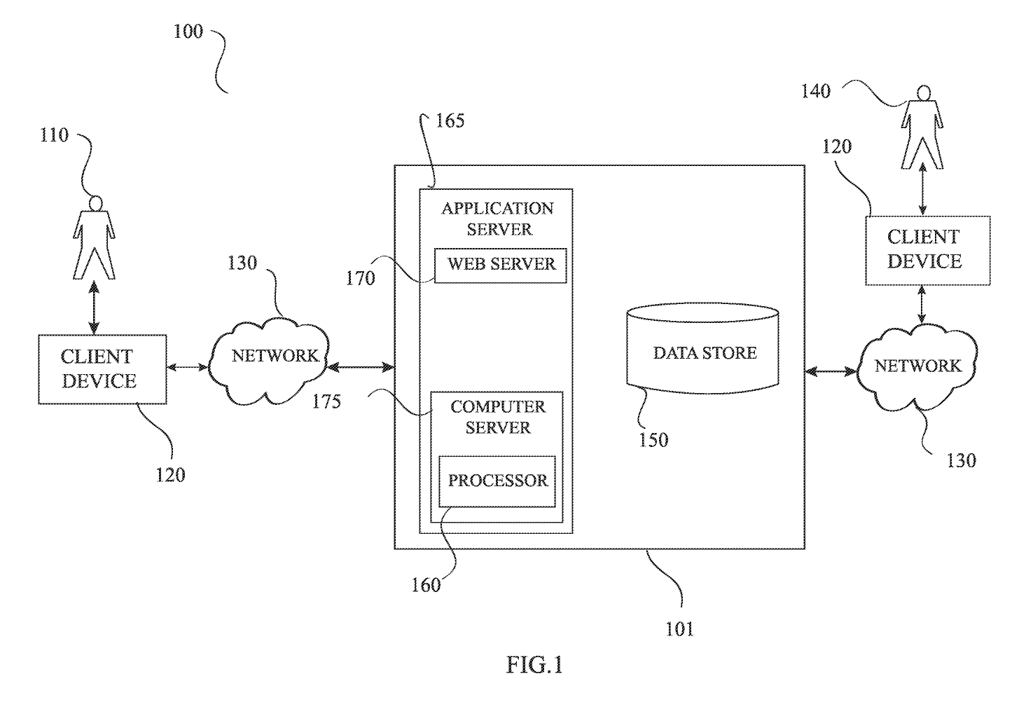

FIG. 1 illustrates the general architecture of a system 100 that operates in accordance with one embodiment of the present invention. One or more client devices 120 are connected to a computational device 101 via a network 130. The computational device 101 communicates with the client devices 120 over the network 130 to present a user interface for the sporting event wagering system of the present invention. The user interface of the sporting event wagering system of the present invention can be a website presented through a web browser or a mobile application (mobile application is also referred to as mobile app hereinafter) communicating with the computational device 101 used for displaying, entering, and/or managing data for the sporting event wagering system of the present invention. Hereinafter, both the website and the mobile app of the sporting event wagering system of the present invention are referred to as user interface only. The client devices 120 may be any device capable of presenting and displaying data and having an input device. Examples of client device 120 may include, but not limited to, personal computers, server computers, mobile devices, tablets, hand-held or laptop devices, smart phones, personal digital assistants or any similar devices. As used herein, the term “network” generally refers to any collection of distinct networks working together to appear as a single network to a user. The term also refers to the so-called world wide “network of networks” i.e. Internet which is connected to each other using the Internet protocol (IP) and other similar protocols. The Internet provides file transfer, remote log in, electronic mail, and other services. As described herein, the exemplary public network 130 of FIG. 1 is for descriptive purposes only and it may be wired or wireless. Although the description may refer to terms commonly used in describing particular public networks such as the Internet, the description and concepts equally apply to other public and private computer networks, including systems having architectures dissimilar to that shown in FIG. 1.

With respect to the present description, the computational device 101 may include any service that relies on a database system that is accessible over a network, in which various elements of hardware and software of the database system may be shared by one or more users of the system 100. In FIG. 1 users are depicted by 110 and 140. The GUI or user interface provided by the computational device 101 on the client devices 120 may be utilized by the users for signing up, submitting data, receiving information from another user, making transactions etc.

The components appearing in the computational device 101 refer to an exemplary combination of those components that would need to be assembled to create the infrastructure in order to provide the tools and services contemplated by the present invention. As will be apparent to one skilled in the relevant art(s), all of components “inside” of the computational device 101 may be connected and may communicate via a wide or local area network (WAN or LAN).

The computational device 101 includes an application server or executing unit 165 and a data store 150. The application server or executing unit 165 comprises a web server 170 and a computer server 175 that serves as the application layer of the present invention. It would be obvious to any person skilled in the art that, although described herein as the data being stored in a single database, different separate databases can also store the various data and files of multiple users.

The Web server 170 is a system that sends out Web pages containing electronic data files in response to Hypertext Transfer Protocol (HTTP) requests from remote browsers (i.e. browsers installed in the client devices 120) or in response to similar requests made through a mobile app or mobile application of the present invention installed on a client device 120. That is, the Web server 170 provides the user interface of the sporting event wagering system of the present invention in the form of Web pages in client devices 120 through web browsers. The web server 170 can also communicate with the mobile app of the present invention installed on a client device 120 to provide the user interface required for the sporting event wagering system.

The computer server 175 may include a processor 160, a random access memory (RAM) (not shown in figures) for temporary storage of information, and a read only memory (ROM) (not shown in figures) for permanent storage of one or more computer-readable instructions which can be executed by the processor 160 to implement the method of the sporting event wagering system of the present invention. Computer server 175 may be generally controlled and coordinated by an operating system software. The operating system controls allocation of system resources and performs tasks such as processing, scheduling, memory management, networking, and I/O services, among things. Thus, the operating system resides in system memory and executed by CPU coordinates the operation of the other elements of the computational device 101.

Although, the description of the computer server 175 may refer to terms commonly used in describing particular computer servers, the description and concepts equally apply to other processing systems, including systems having architectures dissimilar to that shown in FIG. 1.

Reference to FIG. 1, by way of example, it is assumed that user 110 is a user who is interested in predicting winners of games in sporting events. Hereinafter, user 110 is referred to as first user 110. Similarly, user 140, hereinafter referred to as second user 140, is another user who is also interested in predicting game winners in sporting events. Although, only two client devices 120 and only two users 110 and 140 are shown in FIG. 1, it would be obvious to those skilled in the art there could be a plurality of client devices and users which can be a part of the sporting event wagering system of the present invention.

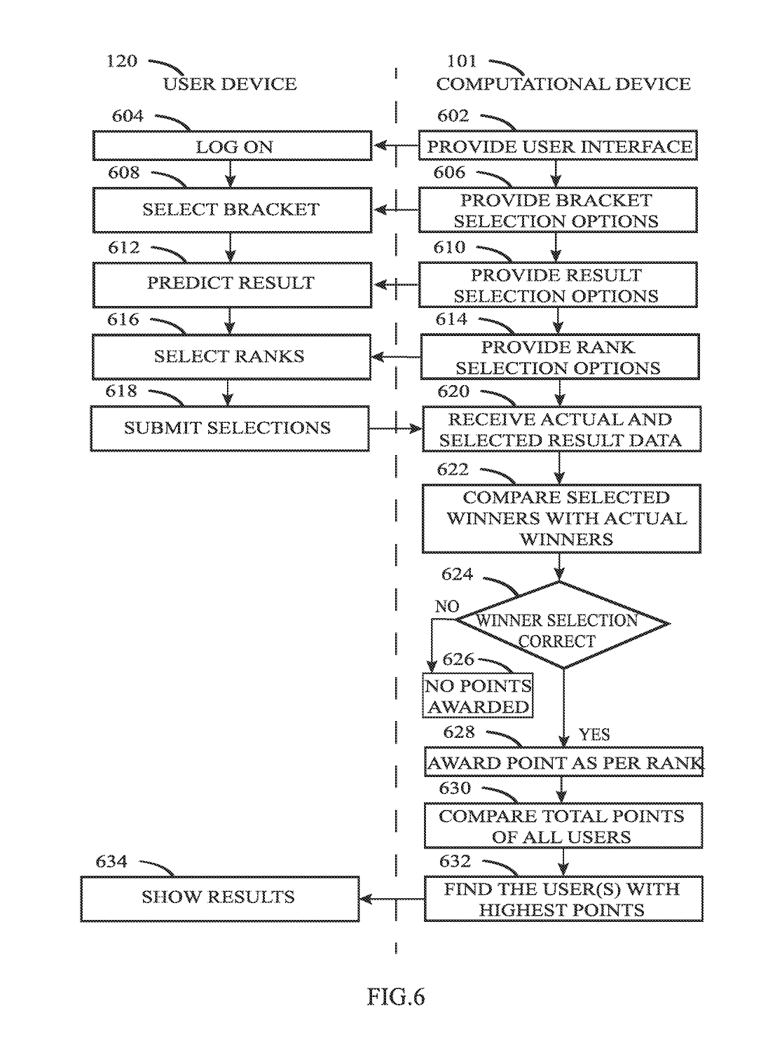

In a preferred embodiment, the first user 110 and second user 140 are required to sign up with the sporting event wagering system 100 provided by computing device 101 through the user interface presented on the client devices 120. For example, a user can open the mobile app of the present invention installed on a client device and sign up with the sporting event wagering system by providing requisite information. For a user, the information required to sign up may include, but not limited to, information related to the user's valid identity, payment mode etc. All such information required for signing up with the sporting event wagering system can be submitted through the user interface. In some embodiments, the first user 110 and the second user 140 would be required to submit valid proof to substantiate the information submitted for signing up. A registered user can log on, as in step 604 of FIG. 6, using the user interface provided by the sporting event wagering system 100 as in step 602. In some embodiments, a user can use the sporting event wagering system 100 without being a registered user.

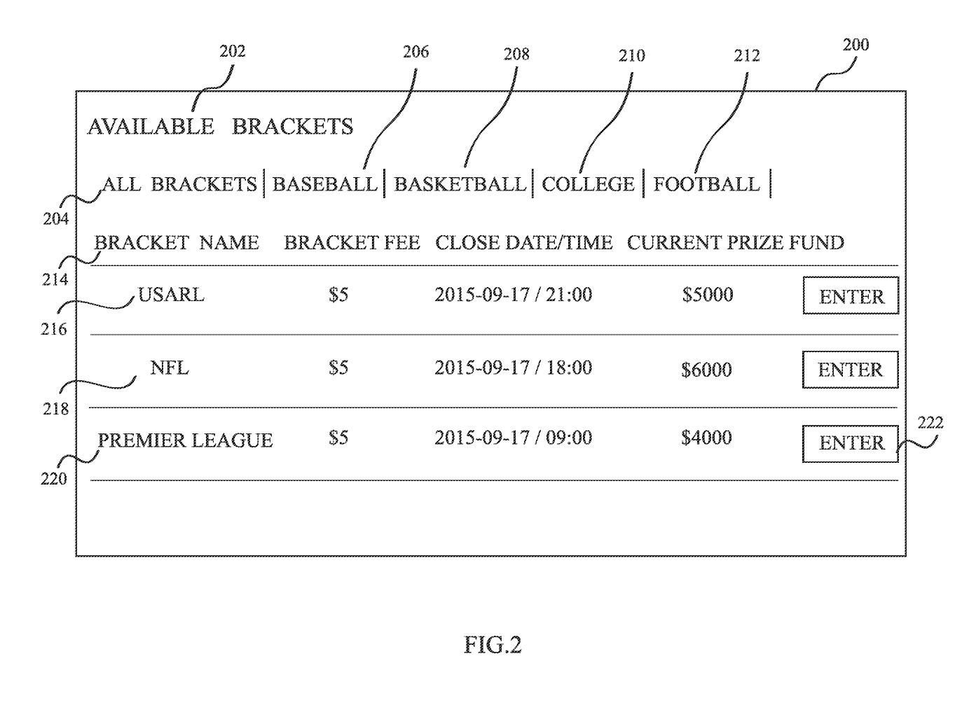

FIG. 2 shows a screen 200 of the user interface presented on a display of a client device 120 by the sporting event wagering system 100 as in step 606 of FIG. 6. Screen 200 of user interface enables a user to select a bracket from a plurality of brackets made available under the heading “Available Brackets” 202. In the context of the present invention, the term “bracket” is used herein to refer to a group of real games which may comprise of a plurality of games played within a specific time period in a particular real sporting event. For example, for a real football league, a bracket can include all the real games played within a week among a plurality of real teams. In another example, for baseball, a bracket can be defined to include games played on per day basis. Such brackets are made available on the user interface preferably in advance before the start of the opening game included in the bracket. In the exemplary screen 200 of the user interface, options of selectable brackets available under heading 202 are All Brackets 204, Baseball 206, Basketball 208, College 210 and Football 212.

In FIG. 2, if the first user 110 selects the option All Brackets 204, the brackets available at that instant of time from all the sports categories are presented on the screen 200 of the user interface. The brackets shown on screen 200 of the user interface in FIG. 2 under category All Brackets 204 are USARL (USA Rugby League) 214, NFL (National Football League) 216 and Premier League 218. Along with the bracket names 214, some other information, such as bracket fee, close date/time, current prize funds etc., relevant to the brackets are also provided on the user interface 200. The bracket fee (e.g. $5) is the fee which a user may be required to pay to participate in the game proposed by the present invention. The close date/time (e.g. 2015-09-17/21:00) indicates the date and time upto which a bracket will remain available on the user interface for selection. The current prize fund indicates the prize fund that gets accumulated against a particular bracket. A user can select any of the available brackets by clicking on the Enter button 222 shown against each of the selectable brackets.

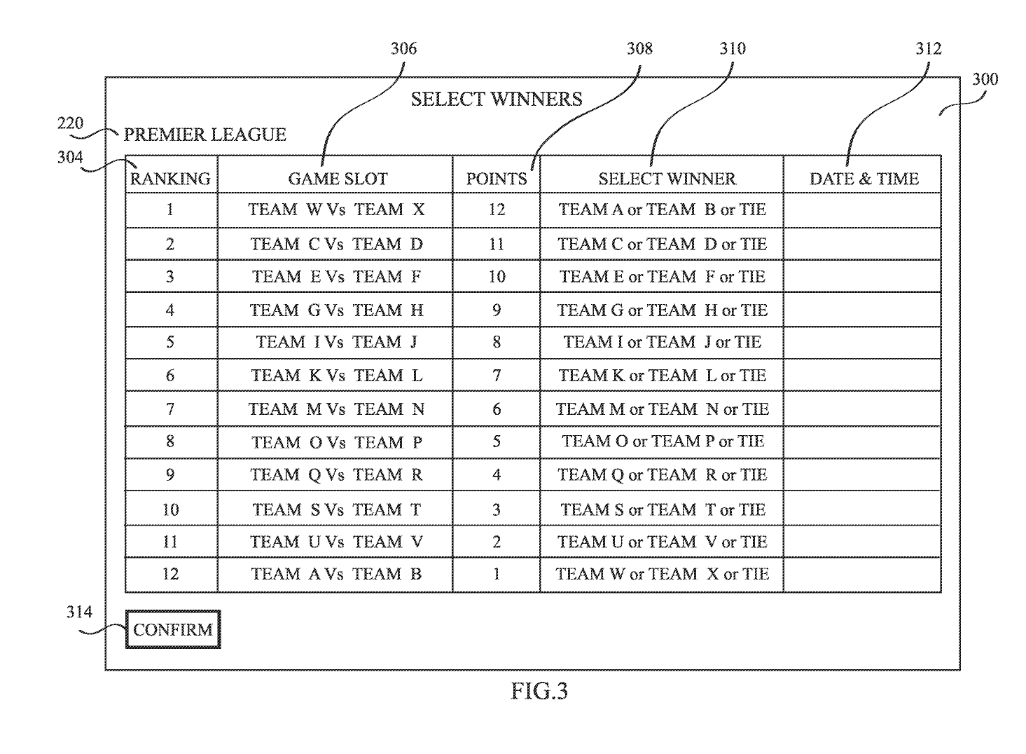

FIG. 3 illustrates an exemplary screen 300 of the user interface in accordance with a preferred embodiment of the present invention if the user selects any of the brackets, for example, bracket “Premier League” 220, on the screen 200 as in step 608 in FIG. 6. The user interface, as shown on screen 300, presents a list of all the actual games that are included in the bracket “Premier League” 220 under the game slots 306. When presented initially on the user interface, the games are shown arbitrarily distributed among the game slots 306. The user interface provides a ranking order for the games included in the bracket. The ranking order gives a ranking number for each of the game slots. In a preferred embodiment, the ranking numbers equal the total number of games included in the bracket and the rank order starts by assigning the first rank number to the first game slot on the user interface. The subsequent game slots are then assigned rank numbers in the descending order. In the present example, the “Premier League” bracket includes 12 numbers of games and, as such, the rank order defines a total of 12 ranks starting from 1 to 12 under the ranking column “Ranking” 304. Although, only 12 numbers of games are shown included in the bracket “Premier League”, it would be obvious to anyone skilled in the art that any number of games can be included in a bracket.

The column “Points” 308 indicates points allotted against each of the game slots 306 based on the ranking of the game slots in the rank order. In a preferred embodiment, the top ranked game slot is allotted with highest number of points compared to the rest of the game slots and the point allocation reduces gradually to the bottom ranked game slot. In the present example, as shown on screen 300 of the user interface, a maximum of 12 points are allotted against game slot ranked 1 and only 1 point is allotted against game slot ranked 12. The user interface allows a user to predict a winner for each of the games by selecting a result option from the selectable options provided under column “Select Winner” 310 against each of the game slots as in step 610 of FIG. 6. In some embodiments, the result options include a selectable option of draw or tie as a result prediction against each game of the bracket. The “Date and Time” 312 column shows the date and time of the real games to be played.

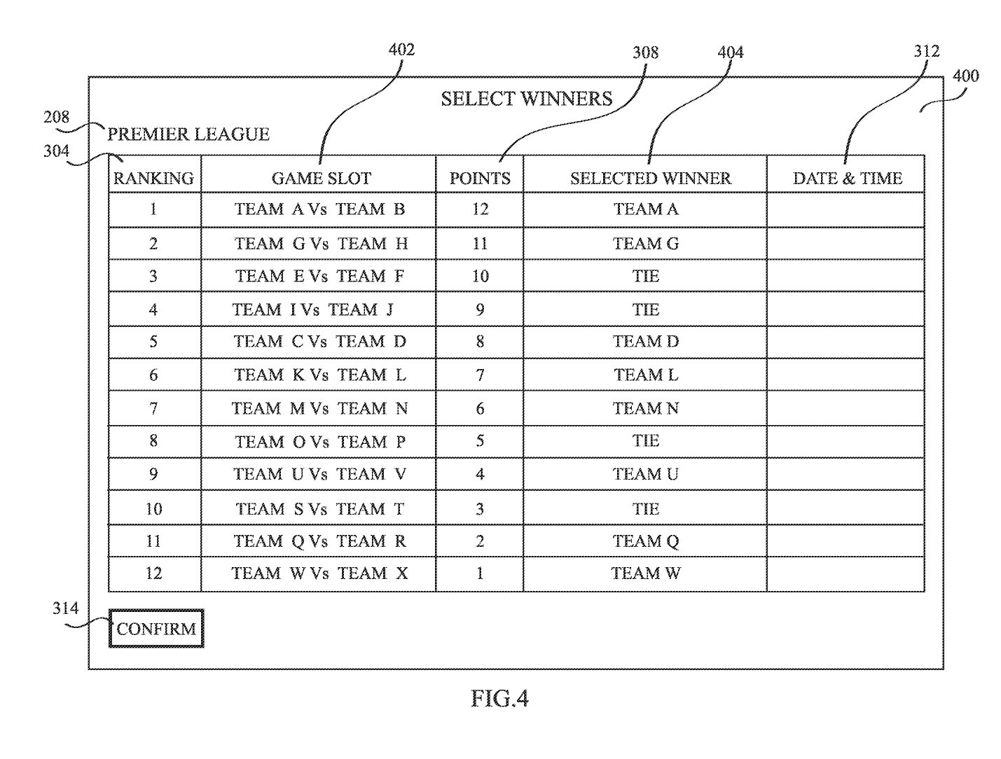

Column 404 on screen 400 of the user interface in FIG. 4 shows predictions made by a user in terms of result for each of the games as in step 612. The user interface of the present invention also allows the user to rearrange the games in the game slots in any desired way as in step 614 of FIG. 6. A user can rank any of the available games as top ranked game by placing that game in the first game slot provided against the first rank. When a user selects a game result it is likely that the user will not have the same level of confidence in the game result predictions for all the games. Accordingly, the user is supposed to rank all the games in an order in which the user feels confident about making the right game result prediction. That implies, the user should rank that game as the top ranked game the result of which the user is most confident about in predicting. Similarly, for other games also, the user should place the games in the ranks based on probability of making right game result prediction. For example, first user 110 may feel most confident about Team A winning against Team B among all the other game result prediction which the first user 110 is making and, thus, the first user 110 selects Team A as the winner under column 404 and puts the game between Team A and Team B at the top of the rankings in the first game slot under column 402 on the user interface as shown on screen 400 of FIG. 4. The points allotted for the right result prediction for the game placed at the top of the ranking table is shown to be 12 points in the present example under “Points” 308 column as shown on screen 400. The points allotted against the correct game result predictions are gradually reduced from top to bottom in the list. In the present example, the points come down to just 1 for the correct game result prediction for the game between Team W versus Team X which has been placed at the bottom of the game slots by the first user 110. Among all the games in the bracket for which a user is predicting the results, the user should place that game at the top of the ranking the outcome of which the user is most confident about. In another example, for the same bracket, a second user 140 may feel that Team M will definitely win the game to be played between Team M and Team N and the second user 140 also believes that this is the game result prediction he/she is making which has the highest probability of becoming true among all the predictions the second user 140 is making regarding the outcome of the games in the bracket. Therefore, in this example, the second user 140 should place the game to be played between Team M and Team N at the top of the ranking i.e. at rank 1. A user should place the other games in the ranking as per his/her level of confidence in making the predictions about the outcome/result of each individual game. So, it is likely that, when a plurality of users uses the sports wagering system of the present invention, the results predicted by the users and the position of the games ranked by the users are all can be different in most of the instances or can be same in some rare instances.

Once a user predicts game results and finalizes the ranks for the games, the user can submit the data by clicking on the “Confirm” 314 button on the screen 400 as in step 618 in FIG. 6. In some embodiments, the user is allowed to change his/her result prediction and ranking selection for a bracket upto a time when play for the first of the games included in the selected bracket starts. The user interface allows a user to change the position of the games in the game slots within the bracket at any time before or after submission in some embodiments.

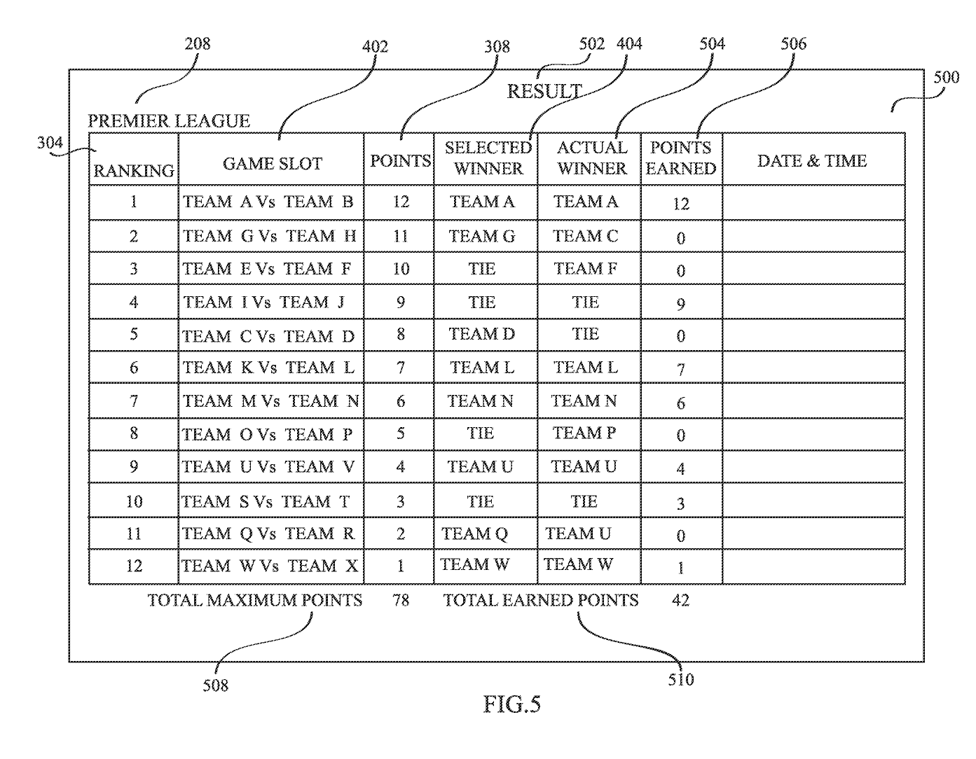

Once the real games included in a bracket are played and actual results are out, the actual results are fed into the computational device 101 by the system administrator. The computational device 101, upon receiving the actual result data and the users selected data from the client devices as in step 622, compares the data received. If the computational system 101 finds that the actual result of a game does not match the user's prediction for that game then no point is awarded against that prediction of the user as in step 626. If the prediction of a user comes true i.e. if the actual result matches the predicted result, then the user is awarded full points against that game as per the ranking of the game. In the first example, as shown on screen 500 of FIG. 5, the prediction of first user 110 for the Team A as the winner of the game between Team A and Team B was found to be right and as this game was positioned at the top game slot in the bracket, the first user 110 gets 12 points for this game. For the same game between Team A and Team B, had the first user 110 placed the game at any other rank, for example at rank 8 and had Team A won, the first user 110 would have earned only 5 points as against 12 points for making the right prediction and keeping the game at the top of the list. Accordingly, in the present example, screen 500 shows that predictions made by the first user 110 were wrong for the games placed at the rank 2 and rank 3 and, thus, the first user 110 earns no points against the predictions made for these two games. Similarly, for all the games included in the bracket, the computational system 101 compares the actual results with the predicted results as in step 624 and points are awarded, as in step 628, or not awarded, as in step 626, based on right or wrong predictions. In some embodiments, a user may be awarded half the points allotted for the game in the ranking if the game result is a tie against the user's prediction of win or loss for a team of the game. The computational device 101 calculates the total points earned by the first user 110 for his/her predictions for all the games in the bracket which, in the present example, is 42 points shown as “Total Earned Points” 510 as against a 78 “Total Maximum Points” 508 shown on screen 500.

The computational device 101 calculates points earned by all the users who submit their predictions through the sports wagering system of the present invention and compares those as in step 630 of FIG. 6. The computational device 101 then finds the one or more users which earn the maximum number of points as in step 632. The results of the winning one or more users are made available through the user interface on the client devices as in step 634.

In some embodiments, a single user is allowed to submit multiple different predictions for the same bracket.

The sporting event wagering system of the present invention provides both paid games option and free games options for participating users. For paid games, the total prize money can be distributed evenly among the winners as per the ranks if there more than one user earns same points. For example, the first ranked one or more user winners, who earn the most points, can share 75% of the total prize money and the second ranked one or more user winners are given 20% of the total prize money. In some embodiments, the participation fee may be fixed while in some other embodiments, users are allowed to put wager at any desired value.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

References to “a processor” or “the processor,” can be understood to include one or more microprocessors that can communicate in a stand-alone and/or a distributed environment(s), and can thus be configured to communicate via wired or wireless communications with other processors, where such one or more processor can be configured to operate on one or more processor-controlled devices that can be similar or different devices. Furthermore, references to data store, unless otherwise specified, can include one or more processor-readable and accessible memory elements and/or components that can be internal to the processor-controlled device, external to the processor-controlled device, and can be accessed via a wired or wireless network.

Flowchart is used to describe the steps of the present invention. While the various steps in the flowchart are presented and described sequentially, some or all of the steps may be executed in different orders, may be combined or omitted, and some or all of the steps may be executed in parallel. Further, in one or more of the embodiments of the invention, one or more of the steps described above may be omitted, repeated, and/or performed in a different order. In addition, additional steps, omitted in the flowchart may be included in performing this method of the present invention. Accordingly, the specific arrangement of steps shown in FIG. 6 should not be construed as limiting the scope of the invention.

It is specifically intended that the present invention not be limited to the embodiments and illustrations contained herein and the claims should be understood to include modified forms of those embodiments including portions of the embodiments and combinations of elements of different embodiments as come within the scope of the following claims.

What is claimed is:

1. A system for sporting event wagering, said system comprising:
one or more client devices having a data input and a data display option; and
at least one computational device communicatively connected to said one or more client devices through a network, said at least one computational device having one or more data stores and one or more processors, said at least one computational device is operable to, at least;
provide a user interface on said one or more client devices;
present one or more selectable brackets on said user interface, each of said one or more selectable brackets comprising a plurality of games corresponding to a real sporting event;
present said plurality of games included in a bracket along with a plurality of game slots arranged in a ranking order on said user interface on selection of said bracket by one or more users from said one or more selectable brackets, said ranking order starting serially with a highest ranking number assigned to a top game slot from said plurality of game slots;
allot points to each of said plurality of game slots corresponding to said ranking order with maximum points allotted to said highest ranking number;
receive selection of a game result prediction made by said one or more users for each of said plurality of games via said user interface;
allow placing of each of said plurality of games by said one or more users in each of said plurality of game slots;
receive a plurality of actual results for said plurality of games of said real sporting event to compare said plurality of actual results with said game result prediction for each of said plurality of games;
award said allotted points to said one or more users for those of said plurality of games for which said plurality of actual result match said game result prediction on said comparison; and
calculate total points awarded to each of said one or more users for said bracket to declare one or more winners from said one or more users.

2. The system of claim 1, wherein said placing of each of said plurality of games by said one or more users in each of said plurality of game slots is based on confidence of said one or more users have on said game result prediction.

3. The system of claim 1, wherein for said selection of said game result prediction a plurality selectable result options are provided on said user interface.

4. The system of claim 3, wherein said plurality of selectable result options include a winner selection option and a game draw selection option.

5. The system of claim 1, wherein said selection of said bracket, said selection of said game result prediction and said placing of said plurality of games in said plurality of game slots by said one or more users for each of said bracket are allowed multiple times.

6. A computer implemented method for sporting event wagering in a system, said system comprising one or more client devices having a data input and a data display options and at least one computational device communicatively connected to said one or more client devices through a network to provide a user interface on said client devices, said at least one computational device having one or more data stores and one or more processors, said at least one computational device is operable to at least one request, said method comprising the steps of:
providing a user interface on said one or more client devices;
presenting one or more selectable brackets on said user interface, each of said one or more selectable brackets comprising a plurality of games corresponding to a real sporting event;
presenting said plurality of games included in a bracket along with a plurality of game slots arranged in a ranking order on said user interface on selection of said bracket by one or more users from said one or more selectable brackets, said ranking order starting serially with a highest ranking number assigned to a top game slot from said plurality of game slots;
allotting points to each of said plurality of game slots corresponding to said ranking order with maximum points allotted to said highest ranking number;
receiving selection of a game result prediction made by said one or more users for each of said plurality of games via said user interface;
allowing placing of each of said plurality of games by said one or more users in each of said plurality of game slots;
receiving a plurality of actual results for said plurality of games of said real sporting event to compare said plurality of actual results with said game result prediction for each of said plurality of games;
awarding said allotted points to said one or more users for those of said plurality of games for which said plurality of actual result match said game result prediction on said comparison; and
calculating total points awarded to each of said one or more users for said bracket to declare one or more winners from said one or more users.

7. The method of claim 6, wherein said placing of each of said plurality of games by said one or more users in each of said plurality of game slots is based on confidence of said one or more users have on said game result prediction.

8. The method of claim 6, wherein for said selection of said game result prediction a plurality selectable result options are provided on said user interface.

9. The method of claim 8, wherein said plurality of selectable result options include a winner selection option and a game draw selection option.

10. The method of claim 6, wherein said selection of said bracket, said selection of said game result prediction and said placing of said plurality of games in said plurality of game slots by said one or more users for each of said bracket are allowed multiple times.

11. A non-transitory computer readable storage media storing instruction, said instructions causing a computational device to perform a method, said method comprising:
providing a user interface on said one or more client devices;
presenting one or more selectable brackets on said user interface, each of said one or more selectable brackets comprising a plurality of games corresponding to a real sporting event;
presenting said plurality of games included in a bracket along with a plurality of game slots arranged in a ranking order on said user interface on selection of said bracket by one or more users from said one or more selectable brackets, said ranking order starting serially with a highest ranking number assigned to a top game slot from said plurality of game slots;
allotting points to each of said plurality of game slots corresponding to said ranking order with maximum points allotted to said highest ranking number;
receiving selection of a game result prediction made by said one or more users for each of said plurality of games via said user interface;
allowing placing of each of said plurality of games by said one or more users in each of said plurality of game slots;
receiving a plurality of actual results for said plurality of games of said real sporting event to compare said plurality of actual results with said game result prediction for each of said plurality of games;
awarding said allotted points to said one or more users for those of said plurality of games for which said plurality of actual result match said game result prediction on said comparison; and
calculating total points awarded to each of said one or more users for said bracket to declare one or more winners from said one or more users.

12. The non-transitory computer readable storage media claim 11, wherein said placing of each of said plurality of games by said one or more users in each of said plurality of game slots is based on confidence of said one or more users have on said game result prediction.

13. The non-transitory computer readable storage media claim 11, wherein for said selection of said game result prediction a plurality selectable result options are provided on said user interface.

14. The non-transitory computer readable storage media claim 13, wherein said plurality of selectable result options include a winner selection option and a game draw selection option.

15. The non-transitory computer readable storage media claim 11, wherein said selection of said bracket, said selection of said game result prediction and said placing of said plurality of games in said plurality of game slots by said one or more users for each of said bracket are allowed multiple times.
